(19) United States
(12) Patent Application Publication
(10) Pub. No.: US 2020/0208530 A1
(43) Pub. Date: Jul. 2, 2020

(54) METHOD FOR MAKING A TURBINE AIRFOIL

(71) Applicant: Siemens Aktiengesellschaft, München (DE)

(72) Inventors: Scott Michael Widrig, Pembroke, VA (US); Michael Stemmler, Dusseldorf (DE)

(21) Appl. No.: 16/642,100

(22) PCT Filed: Aug. 21, 2018
(86) PCT No.: PCT/US2018/047191

§ 371 Date: Feb. 26, 2020

Related U.S. Application Data
(60) Provisional application No. 62/550,767, filed on Aug. 28, 2017.

(51) Int. Cl. F01D 5/18; B22C 9/10

(52) U.S. Cl. CPC F01D 5/187; F05D 2220/32; F05D 2230/211; B22C 9/106

(57) ABSTRACT

A method of making a turbine airfoil includes generating an airfoil core (14) that includes a core exit along an extended portion (28) of the trailing edge (32) outside of the airfoil part geometry. Float points (12) are positioned along the extended portion (28) of the airfoil core (14). Each float point (12) includes a float feature (34) that includes a localized radially straight surface (42) extending out and creating a gap (18) between the airfoil core (14) and the mold shell (16).

### CROSS REFERENCE TO RELATED APPLICATIONS

The present invention claims priority to and the benefit of U.S. Provisional Application No. 62/550,762, filed Aug. 28, 2017, the entirety of which is incorporated by reference herein.

### FIELD

The present invention relates to turbine blades for a gas turbine and, more particularly, to a three dimensional (3D) curved trailing edge core float.

### BACKGROUND

In gas turbine engines, compressed air discharged from a compressor section and fuel introduced from a source of fuel are mixed together and burned in a combustion section, creating combustion products defining a high temperature working gas. The working gas is directed through a hot gas path in a turbine section of the engine, where the working gas expands to provide rotation of a turbine rotor. The turbine rotor may be linked to an electric generator, wherein the rotation of the turbine rotor can be used to produce electricity in the generator.

In view of high pressure ratios and high engine firing temperatures implemented in modern engines, certain components, such as airfoils, e.g., stationary vanes and rotating blades within the turbine section, must be cooled with cooling fluid, such as air discharged from a compressor in the compressor section, to prevent overheating of the components.

Effective cooling of turbine airfoils requires delivering the relatively cool air to critical regions such as along a trailing edge of a turbine blade or a stationary vane. Associated cooling apertures may, for example, extend between an upstream, relatively high pressure cavity within the airfoil and one of the exterior surfaces of the turbine blade. Blade cavities typically extend in a radial direction with respect to the rotor and stator of the machine.

Airfoils also commonly include internal cooling channels which remove heat from the pressure sidewall and the suction sidewall in order to minimize thermal stresses. Achieving a high cooling efficiency based on the rate of heat transfer is a significant design consideration in order to minimize the volume of coolant air diverted from the compressor for cooling. However, the relatively narrow trailing edge portion of a gas turbine airfoil may include, for example, up to about one third of the total airfoil external surface area. The trailing edge is made relatively thin with high detail for aerodynamic efficiency. Consequently, manufacturing of the airfoil and especially the trailing edge area are of great concern.

Current methods of manufacturing ceramic cores for investment casting in order to produce these blades and vanes are sensitive to curvature of the trailing edge. Currently, the methods to resolve sensitivity issues result in every increasing variation in wall thickness of the airfoil at the trailing edge.

As trailing edges become more advanced and fine feature based, the issue of variation is exacerbated further due to increasing number of smaller features. When changes are needed, a whole new core and master tooling need to be manufactured at high costs to reproduce the core.

### SUMMARY

In an aspect of the present invention, a method for making a turbine airfoil, comprises: generating a mold shell; generating an airfoil core comprising a pressure side and suction side that are connected by a trailing edge and a leading edge, a radially outward tip end and a radially inward root end, and a core exit along an extended portion of the trailing edge outside of the airfoil part geometry; and positioning float points along the extended portion of the airfoil core, wherein each float point includes a float feature that includes a localized radially straight surface extending out and creating a gap between the airfoil core and the mold shell.

In another aspect of the present invention, a method for making a turbine airfoil, comprises: generating a mold shell; generating an airfoil core comprising a pressure side and suction side that are connected by the trailing edge and a leading edge, a radially outward tip end and a radially inward root end, and a core exit along an extended portion of the trailing edge outside of the airfoil part geometry; positioning float points along the extended portion of the airfoil core, wherein each float point includes a float feature that includes localized radially straight surface extending out and creating a gap between the airfoil core and the mold shell; introducing molten metal alloy into the gap and surrounding the floats points; solidifying the alloy to form an airfoil casting having a plurality of float point openings at the extended portion location; removing the mold shell so as to expose the airfoil; and sealing the plurality of float point openings in the airfoil.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1 is a trailing edge view of a blade core and mold shell of a conventional technique;

FIG. 2 is a trailing edge view of a curved airfoil blade core and mold shell of the conventional technique;

FIG. 3 is a trailing edge view of an airfoil blade core and mold shell of the exemplary embodiment of the present invention;

FIG. 4 is a perspective trailing edge view of the airfoil blade core;

FIG. 5 is a side view of a portion of a core including a core printout; and

FIG. 6 is a side view of a portion of an airfoil prior to completion of manufacturing.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

Broadly, there is disclosed a method of making a turbine airfoil comprising generating an airfoil core includes a core exit along an extended portion of the trailing edge outside of the airfoil part geometry. Float points are positioned along the extended portion of the airfoil core. Each float point includes a float feature that includes a localized radially straight surface extending out and creating a gap between the airfoil core (14) and the mold shell.

Within the power industry, gas turbine engines are required to provide movement to produce electricity in a generator. In gas turbine engines, compressed air discharged from a compressor section and fuel introduced from a source of fuel are mixed together and burned in a combustion section, creating combustion products defining a high temperature working gas. The working gas is directed through a hot gas path in a turbine section of the engine, where the working gas expands to provide rotation of a turbine rotor. The turbine rotor may be linked to an electric generator, wherein the rotation of the turbine rotor can be used to produce electricity in the generator.

Modern engines and certain components such as airfoils, e.g. stationary vanes and rotating blades within the turbine section, implement high pressure ratios and high engine firing temperatures. As advancements are made, components are seeing higher and higher temperatures and require more and more expensive materials to produce these components.

As trailing edges on turbine blades become more advanced and fine feature based, the manufacturing of these airfoils and the costs involved become more important. Changes need to be made to current methods of manufacturing in order to keep up with these advances, such as curved trailing edges. Components are typically made from ceramic cores. For the purposes of this application, any reference to a ceramic material may also be any other material that functions in a similar fashion. Further, the reference to turbines and the power industry may also be for other processes and products that may require a core made from a casting process. Producing a blade can require first a production of a mold. The mold is produced from a master tooling surface.

A manufacturing process that allows for a reduction in variation in wall thickness while maintaining a proper distance between a core and shell in a master tooling is desirable. Embodiments of the present invention provide a method of manufacturing that may allow for the reduction of cost in manufacturing a master tooling assembly as well as the master tooling assembly itself. The turbine blade and airfoil are used below as an example of the method and tooling assembly; however, the method and tooling assembly may be used for any component requiring detailed features along a core for casting purposes. The turbine blade can be within the power generation industry.

In certain embodiments, materials of construction can be specifically selected to work in cooperation with the casting and firing processes to provide a core that overcomes known problems with prior art cores. The materials and processes of embodiments of the present invention may result in a ceramic body which is suitable for use in a conventional metal alloy casting process.

Generally the investment casting of the blade or vane includes an initial wax pattern. The wax pattern is then coated with the ceramic material. Once the ceramic material is hardened, the internal geometry takes the shape of the casting. The wax is then melted out and molten metal, or similar material, is poured into the cavity where the wax pattern was located. The metal solidifies within the ceramic mold and then the metal casting is broken out. The hardened metal becomes the part such as a blade or vane, or a portion of either. The process can be used to form a plurality of trailing edge passages along the airfoil, for example. Several wax patterns can be combined for a single casting or connecting multiple wax patterns and poured together producing many castings in a single process. For detailed features pre-formed ceramics can be used instead of the soluble wax cores.

For a core to be cast for any extended length of time, the core needs to be supported at points along the core. The core is extended in length to provide an area outside of the detailed portion of the part for the location of these supports. This extended area of the core is called the core printout, or tie bar. These supports, or floats, ensure the core stays in the correct position within the casting and also facilitates the removal of the ceramic from the part after it has been cast. The floats are typically approximately 0.1 mm in thickness and extend out from the core printout. The overall core can typically be fixed in at one end, such as a root end or tip end.

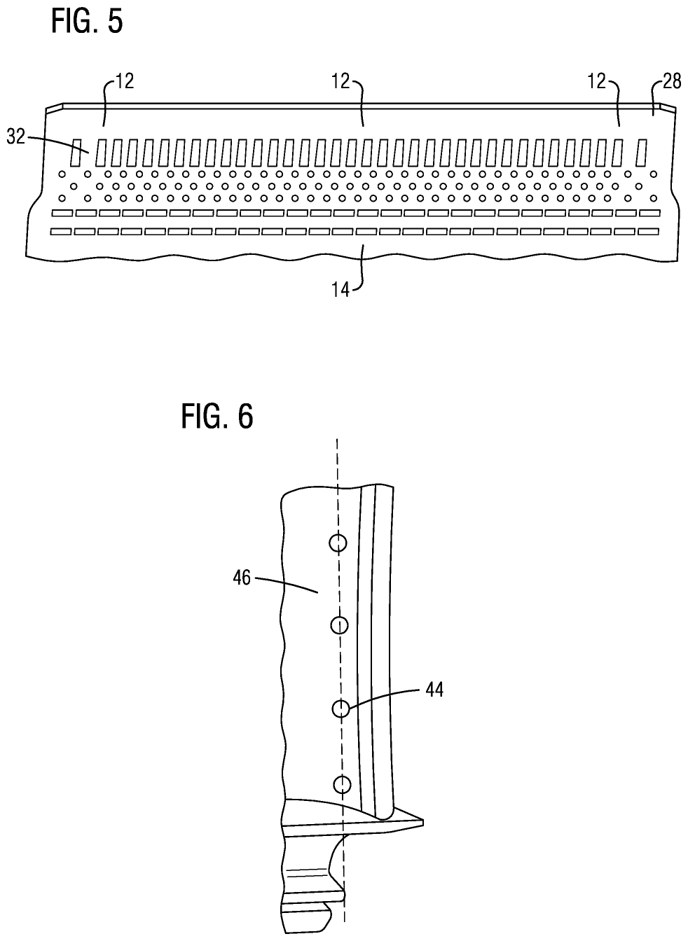

Conventionally, the casting of the part will end at a point along the length of the material of the core, and the floats are applied along an extended portion beyond the casting to stabilize and position the core into the shell so the position cannot move too much. FIG. 5 shows the location of an extended portion 28 along a trailing edge 32 of an airfoil core 14. The floats 12 can be tie bars that are placed along the trailing edge extended portion 28 of the airfoil core 14. The tie bars can run through this trailing edge extended portion 28 so that there is no distortion of the actual airfoil core 14. Possible tie bar locations are pointed out in FIG. 5. These locations can have the tie bars extend out from the page.

In the drawings, the direction X denotes an axial direction parallel to an axis of the turbine engine which the airfoil will be a part of eventually, while the direction R denotes a radial direction with respect to said axis of the turbine engine.

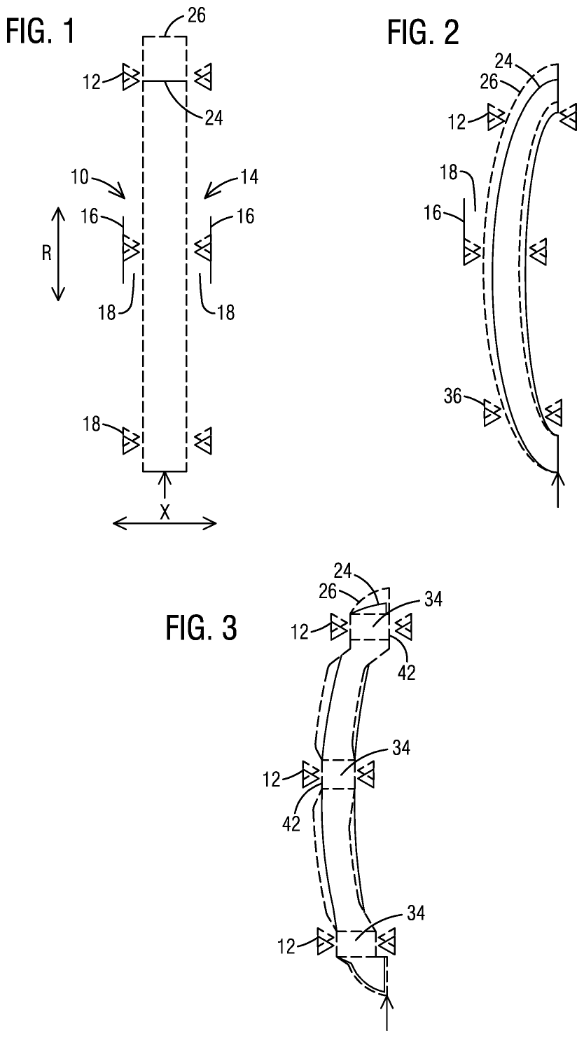

As is illustrated in FIGS. 1 and 2, a master tooling assembly 10 may be put together in order to create a blade or vane. The master tooling assembly 10 provides a mold shell 16. A ceramic core 14, or a core 14 of similar material, is placed within the mold shell 16 for a period of time. The core 14 provides the details for the eventual blade or vane by being a negative of the blade or vane. Specifically, the core 14 can provide advanced details along a trailing edge of an airfoil blade or vane. Generally, there is a spacing, or gap 18, between the mold shell 16 and the core 14 while the blade or vane is being manufactured. The gap 18 is maintained through the use of floats 12. During the manufacturing of the blade or vane airfoil, there is an expansion of the core 14, specifically as radial growth expansion due to temperatures and other factors. FIG. 1 illustrates the change in geometry when there is a radial expansion. The core 14 has an original pre expansion location 24. Expansion occurs and then there is the post expansion location 26 of the core that extends radially outward. As can be seen, the gap 18, or distance between the core 14 and mold shell 16 can remain relatively the same along the axial direction X. The core 14 needs to be able to float relative to the mold shell 16 only enough to prevent excess wall thickness variation without causing contact between the core and the mold shell 16 that causes cores to crack.

For a straight airfoil cores 14, as is shown in FIG. 1, the conventional tooling assembly 10 works appropriately to hold the core 14 in place without causing contact between the core 14 and the mold shell 16. A plurality of float points 12 resides along axial sides of the core 14 to help keep the core 14 in place or checked. These floats 12 are shown as a set of triangles in the FIGS and are positioned radially along each axial side of the core 14. With straight airfoil core 14 there is only a radial expansion that is a concern, assuming no torsion. Contact between the core 14 and mold shell 16 causes cores 14 to crack, so the goal is to keep a separation between the mold shell 16 and core 14 in order to allow the core 14 to grow freely due to expansion. Without the floats 12, there would likely be thickness variations along the core 14 which again can cause breakage.

As mentioned above, advanced detailed trailing edges are being designed to be produced. One aspect of the advanced trailing edges is to have a curved aspect to the radial length, which causes issues with the manufacturing process shown in FIG. 1.

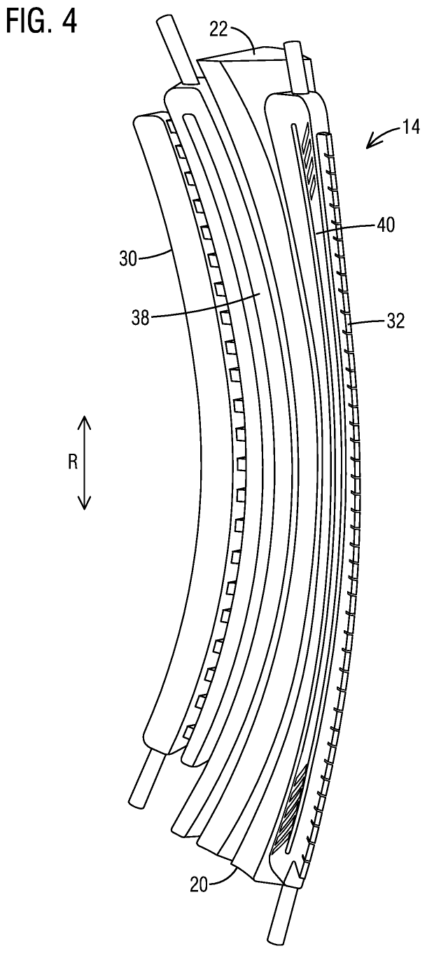

FIG. 4 displays an airfoil core 14 with a curved trailing edge 32. The airfoil core 14 includes a pressure side 38 and suction side 40 that are connected by the trailing edge 32 and a leading edge 30. The airfoil core 14 includes a radially outward tip end 22 and a radially inward root end 20.

The same conventional technique in FIG. 1 is shown in FIG. 2 with the curved airfoil core 14. Having a curved airfoil core 14 provides an additional issue of axial expansion as shown since the airfoil core 14 has radial and axial features. The core 14 expands in both the radial direction R, and in the axial direction X. Expanding in the axial direction X, the gap 18 between the core 14 and the mold shell 16 now become locked 36 in contact. The expansion in the axial direction X removes the gap 18 between the float points 12 of the core 14 and mold shell 16. Currently, the only way to help with this issue is to increase the gap 18 area between the core 14 and the mold shell 16. This increase in gap 18 length, however, only increases the variation in thickness along this trailing edge portion of the eventual blade or vane.

FIG. 3 illustrates an embodiment that includes a plurality of additional float features 34 located in the core 14 near the trailing edge 32 outside of the part geometry in the expanded portion 28. A local radially parallel surface 42 is used in a tie bar of the trailing edge extended portion 28 of the core 14 that ties core exits together. The gaps 18 are not impacted by the curved three-dimensional trailing edges with these float features 34 included. Along the expanded portion 28, the floats 12 are located along the radially flat surfaces 42 of the core 14 so there is no axial expansion effect at these localized places along the airfoil core 14. The radially flat surfaces 42 can vary in radial length based on the geometry of the part and core exit being made. FIG. 3 shows the floats 12 along both sides of the core 14, however, the floats 12 can be positioned only along one side in certain embodiments. Further, the shape of each float 12 can vary as well along the radially flat surface 42. FIG. 6 shows a circular shape while FIG. 3 suggests a square shape. As long as the localized radially flat surface 42 provides a surface for the axial expansion, the float feature 34 and the float points 12 allow for a reduction in variation in wall thickness while maintaining a proper distance between the core 14 and mold shell 16 in a master tooling.

The manufacturing of the airfoil includes the airfoil core 14 surrounded by the mold shell 16. Molten metal alloy or similar material is introduced into the gap 18 and surrounding the floats points 12. The alloy or similar material is solidified to form an airfoil casting having a plurality of float point openings 44 at the extended portion location. The mold shell is removed at this point to expose the airfoil 46. The float point openings in the airfoil are then sealed. FIG. 6 illustrates the float point openings 44.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

What is claimed is:

1. A method for making a turbine airfoil, comprising:
generating a mold shell (16);
generating an airfoil core (14) comprising a pressure side (38) and suction side (40) that are connected by the trailing edge (32) and a leading edge (30), a radially outward tip end (22) and a radially inward root end (20), and a core exit along an extended portion (28) of the trailing edge (32) outside of the airfoil part geometry; and
positioning float points (12) along the extended portion (28) of the airfoil core (14), wherein each float point (12) includes a float feature (34) that includes a localized radially straight surface (42) extending out and creating a gap (18) between the airfoil core (14) and the mold shell (16).

2. The method of claim 1, wherein the floats (12) are along both the pressure side (38) and suction side (40) of the airfoil core trailing edge extended portion (28).

3. The method of claim 1, wherein the floats (12) are along one of the pressure side (38) or suction side (40) of the airfoil core trailing edge extended portion (28).

4. The method of claim 1, wherein the airfoil core (14) includes a curved trailing edge (32) in a radial direction (R).

5. A method for making a turbine airfoil, comprising:
generating a mold shell (16);
generating an airfoil core (14) comprising a pressure side (38) and suction side (40) that are connected by the trailing edge (32) and a leading edge (30), a radially outward tip end (22) and a radially inward root end (20), and a core exit along an extended portion (28) of the trailing edge (32) outside of the airfoil part geometry;
positioning float points (12) along the extended portion (28) of the airfoil core (14), wherein each float point (12) includes a float feature (34) that includes localized radially straight surface (42) extending out and creating a gap (18) between the airfoil core (14) and the mold shell (16);
introducing molten metal alloy into the gap and surrounding the floats points;
solidifying the alloy to form an airfoil casting having a plurality of float point openings (44) at the extended portion (28) location;
removing the mold shell (16) so as to expose the airfoil (46); and
sealing the plurality of float point openings (44) in the airfoil (46).

6. The method of claim 5, wherein the floats (12) are along both the pressure side (38) and suction side (40) of the airfoil core trailing edge extended portion (28).

7. The method of claim 5, wherein the floats (12) are along one of the pressure side (38) or suction side (40) of the airfoil core trailing edge extended portion (28).

8. The method of claim 5, wherein the airfoil core (14) includes a curved trailing edge (32) in a radial direction (R).
